(19) United States
(12) Patent Application Publication
(10) Pub. No.: US 2025/0037056 A1
(43) Pub. Date: Jan. 30, 2025

(54) HIERARCHICAL PARTNER RISK EVALUATION USING FUZZY LOGIC

(71) Applicant: Cisco Technology, Inc., San Jose, CA (US)

(72) Inventors: Qixu Gong, Santa Clara, CA (US); Benjamin L. Chang, Saratoga, CA (US); Qihong Shao, Clyde Hill, WA (US); Gurvinder P. Singh, San Jose, CA (US)

(21) Appl. No.: 18/359,409

(22) Filed: Jul. 26, 2023

(51) Int. Cl. G06Q 10/0635; G06Q 10/0639

(52) U.S. Cl. CPC G06Q 10/0635; G06Q 10/0639

(57) ABSTRACT

Methods are provided which involve obtaining enterprise data about a plurality of assets and configuration of an enterprise network, and partner data about one or more network related partner services for the enterprise network. The methods further involve determining one or more hierarchical relationships among the plurality of assets, the enterprise network, and the one or more network related partner services, by performing machine learning on the enterprise data and the partner data. Additionally, the methods involve generating one or more risk values based on the one or more hierarchical relationships and providing the one or more risk values indicative of performance of the one or more network related partner services.

### TECHNICAL FIELD

The present disclosure generally relates to computer networks and systems.

### BACKGROUND

Enterprise networks include many assets and involve various enterprise service functions for equipment and software. Enterprise networks are often managed by a team of information technology (IT) specialists. This is particularly the case for enterprises that have large networks or systems of numerous instances and types of equipment and software. Tracking performance, troubleshooting, and integrating new technology and/or updates for networking or equipment and software in large enterprise networks is time consuming and often requires support and guidance from providers or third-party entities. In some instances, providers or third-party entities are partner enterprises that assist enterprises in achieving their outcomes by providing partner services. Evaluating quality and/or quantity of partner services is an important aspect for successfully managing enterprise networks.

### BRIEF DESCRIPTION OF THE DRAWINGS

FIG. 1 is a block diagram of a system that includes a hierarchical partner services risk evaluation and recommendation engine that interacts with a service cloud portal and network/computing equipment and software residing at various enterprise sites, according to an example embodiment.

FIG. 2 is a view illustrating hierarchical multiple relations or correlations between partner services, network enterprises, and enterprise devices, which are learned by a hierarchical partner services risk evaluation and recommendation engine, according to an example embodiment.

FIG. 3 is a block diagram illustrating components of a hierarchical partner services risk evaluation and recommendation engine, according to an example embodiment.

FIG. 4 is a diagram illustrating an embedding process in which a hierarchical partner services risk evaluation and recommendation engine generates enterprise data embeddings and partner services data embeddings, according to an example embodiment.

FIG. 5 is a diagram illustrating a fuzzy logic based deep learning process performed by a hierarchical partner services risk evaluation and recommendation engine, according to an example embodiment.

FIG. 6 is a view illustrating fuzzy rules generated by a machine learning and recommendation component of a hierarchical partner services risk evaluation and recommendation engine, according to an example embodiment.

FIG. 7 is a diagram illustrating a method of improving partner services performance based on a partner services risk evaluations, according to an example embodiment.

FIG. 8 is a view illustrating a user interface that provides risk values indicative of performance of partner services together with explanations and actionable insights, according to an example embodiment.

FIG. 9 is a flowchart illustrating a method of providing one or more risk values that are indicative of performance of one or more network related partner services, according to an example embodiment.

FIG. 10 is a hardware block diagram of a computing device that may perform functions associated with any combination of operations in connection with the techniques depicted and described in FIGS. 1-9, according to various example embodiments.

### DETAILED DESCRIPTION

### Overview

Techniques presented herein provide for hierarchical risk evaluations and insights of partner services using fuzzy deep learning and graph neural network.

In one form, a method is provided which includes obtaining enterprise data about a plurality of assets and configuration of an enterprise network, and partner data about one or more network related partner services for the enterprise network. The method further involves determining one or more hierarchical relationships among the plurality of assets, the enterprise network, and the one or more network related partner services, by performing machine learning on the enterprise data and the partner data. Additionally, the method involves generating one or more risk values based on the one or more hierarchical relationships and providing the one or more risk values indicative of performance of the one or more network related partner services.

### Example Embodiments

Enterprises are often assisted by network related partner services. Network related partner services may help an enterprise to onboard new network devices onto their enterprise network. Network related partner services may handle upgrades of the network devices, perform license management for the devices in the enterprise network, help with configuration and features in the enterprise network, manage security aspects of the enterprise network, help progress enterprise network technologies along an adoption lifecycle, address network issues, etc. These are just some non-limiting examples of network related partner services. The network related partner services depend on a particular use case and deployment scenario.

Various digital platforms assist enterprises and network related partner services in managing enterprise networks and network assets. For example, enterprise cloud portal serves as a one-stop destination for equipment and software of an enterprise. The enterprise cloud portal may provide insights and expertise to manage network assets and configuration of an enterprise network. Partner experience cloud portal is a digital platform that assists in providing services to enterprises e.g., customers. The partner experience cloud portal monitors enterprise data of various enterprise networks and may provide supporting materials for enterprises to achieve their outcomes quickly and with satisfaction.

Understanding the risks of network related partner services across various perspectives helps control and improve partner services. For enterprises, evaluating and/or understanding efficiency and efficacy of network related partner services helps achieve their outcomes. However, because of the intricate hierarchical relationships between network devices, network device configurations, enterprises, and network related partner services, determining one or more risk values of the network related partner services is not easy. Evaluating risks or deficiencies of network related partner services may involve a thorough understanding of managed enterprises and their enterprise networks, which is difficult to achieve.

The techniques presented herein provide a hierarchical partner services risk evaluation and recommendations engine (HPRE) that evaluates risks of network related partner services based on understanding various hierarchical relationships. The HPRE generates risk values for various attributes or categories of risks associated with the network related partner services. The HPRE may further generate an overall partner services risk score with an explanation that includes interpretive or fuzzy rules that were used to generate the partner services risk score and/or risk values. The HPRE may further generate recommendations for improving the risk values and/or the partner services risk score, configuration actions to be performed on enterprise networks to modify (i.e., improve) the one or more risk values and the partner services risk score, actionable insights.

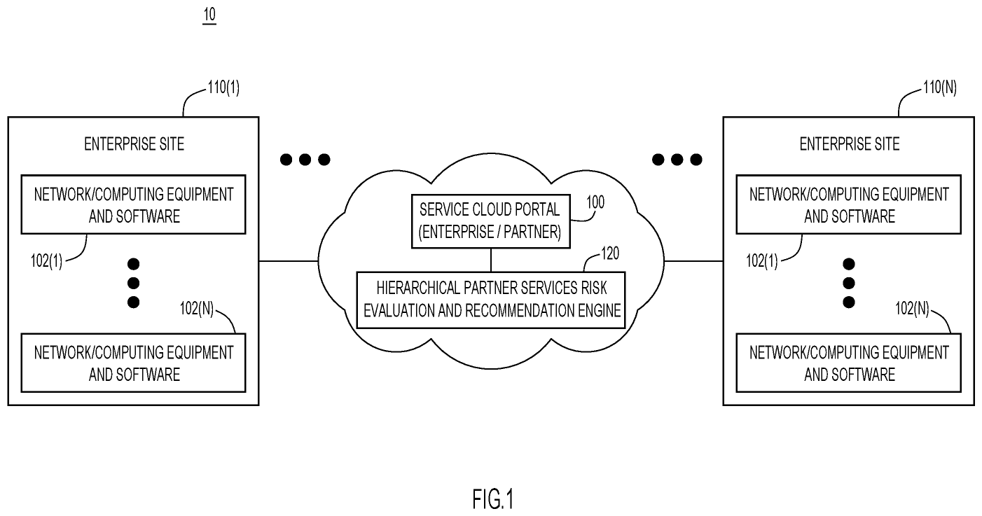

FIG. 1 is a block diagram of a system 10 that includes a hierarchical partner services risk evaluation and recommendation engine (HPRE 120) that interacts with a service cloud portal (cloud portal 100) and network/computing equipment and software 102(1)-102(N) residing at various enterprise sites 110(1)-110(N), or in cloud deployments of an enterprise, according to an example embodiment.

The notations 1, 2, 3, . . . n; a, b, c, . . . n; “a-n”, “a-d”, “a-f”, “a-g”, “a-k”, “a-c”, and the like illustrate that the number of elements can vary depending on a particular implementation and is not limited to the number of elements being depicted or described. Moreover, these are examples of various components, and the number and types of components, functions, etc. may vary based on a particular deployment and use case scenario.

The network/computing equipment and software 102(1)-102(N) are resources or assets of an enterprise (the terms “assets” and “resources” are used interchangeably herein). The network/computing equipment and software 102(1)-102(N) may include any type of network devices or network nodes such as controllers, access points, gateways, switches, routers, hubs, bridges, gateways, modems, firewalls, intrusion protection devices/software, repeaters, servers, and so on. The network/computing equipment and software 102(1)-102(N) may further include endpoint or user devices such as a personal computer, laptop, tablet, and so on. The network/computing equipment and software 102(1)-102(N) may include virtual nodes such as virtual machines, containers, point of delivery (POD), and software such as system software (operating systems), firmware, security software such as firewalls, and other software products. The network/computing equipment and software 102(1)-102(N) may be in a form of software products that reside in an enterprise network and/or in one or more cloud(s). Associated with the network/computing equipment and software 102(1)-102(N) is configuration data representing various configurations, such as enabled and disabled features. The network/computing equipment and software 102(1)-102(N), located at the enterprise sites 110(1)-110(N), represent information technology (IT) environment of an enterprise.

The enterprise sites 110(1)-110(N) may be physical locations such as one or more data centers, facilities, or buildings located across geographic areas that are designated to host the network/computing equipment and software 102(1)-102(N). The enterprise sites 110(1)-110(N) may further include one or more virtual data centers, which are a pool or a collection of cloud-based infrastructure resources specifically designed for an enterprise, and/or for a cloud-based service provider.

The network/computing equipment and software 102(1)-102(N) may send to the cloud portal 100, via telemetry techniques, data about their operational status and configurations so that the cloud portal 100 is continuously updated about the operational status, configurations, software versions, etc. of each instance of the network/computing equipment and software 102(1)-102(N) of an enterprise.

The cloud portal 100 includes an enterprise service cloud portal and/or partner services cloud portal. The cloud portal 100 is driven by human and digital intelligence that serves as a one-stop destination for equipment and software of an enterprise to access insights and expertise when employed, and specific to a particular stage of an adoption lifecycle. Examples of capabilities include assets and coverage, cases (errors or issues to troubleshoot), automation workbench, insights with respect to various stages of an adoption lifecycle and action plans to progress to the next stage, and so on. The cloud portal 100 helps the enterprise network technologies to progress along an adoption lifecycle based on adoption telemetry and enabled through contextual learning, support content, expert resources, and analytics and insights embedded in context of the enterprise's current/future guided adoption tasks.

A network technology is a computing-based service or a solution that solves an enterprise network or a computing problem or addresses a particular enterprise computing use. The network technology may be offered by a service provider to address aspects of information technology (IT). The network technology may be offered by a partner enterprise and is an example of a partner service provided to an enterprise.

Some non-limiting examples of a network technology include access policies, security and firewall protection services, software image management, endpoint or user device protection, network segmentation and configuration, software defined network (SDN) management, data storage services, data backup services, data restoration services, voice over internet (VOIP) services, managing traffic flows, analytics services, security related services, license management, etc. Some network technology solutions apply to virtual technologies or resources provided in a cloud or one or more data centers. The network technology solution implements a particular enterprise outcome and is often deployed on one or more of the network/computing equipment and software 102(1)-102(N).

An adoption of network technology solution refers to enterprise's uptake and utilization of a network technology for achieving a desired outcome. A journey refers to end-to-end activities performed by an enterprise when adopting a network technology including tasks they perform and defined stages to progress. An adoption lifecycle refers to a step-by-step guidance along the adoption journey to accelerate the speed to value of a network technology. The adoption lifecycle may encompass the end-to-end journey stages of: need, evaluate, select, align, purchase, onboard, implement, use, engage, adopt, optimize, recommend, advocate, and accelerate.

As noted above, various IT specialists interact with the cloud portal 100 to manage equipment and software of the enterprise. There are many factors for a user to consider when building, operating, and maintaining enterprise network(s) and/or data center(s). Enterprises typically involve 3^{rd} parties that help enterprises with these tasks. 3^{rd} parties may include partner enterprises that provide various network related partner services. The network related partner services help enterprises with enterprise network management and data center(s) operations. Network related partner services may help manage network/computing equipment and software 102(1)-102(N) of an enterprise.

The partner service cloud portal (cloud portal 100) allows a partner enterprise to manage various network related partner services provided to enterprises. From the partner services perspective, the cloud portal 100 may provide an enterprise by enterprise view (enterprise management view) for managing enterprises serviced by the partner enterprise. The cloud portal 100 may provide analytical views for analyzing a particular network related partner service and comparative views for management and analysis across multiple enterprises i.e., clients of the partner services. It is important for partner services to understand various risks involved with partner services and benchmark against other partner services. Partner services desire a way to identify shortcomings in service delivery and management for existing enterprises so that partner services are improved and perform more similarly to other high-performing partner services.

The HPRE 120 is configured to evaluate risks in network related partner services and provide suggested actions to address the risks to improve performance of the partner services and management of enterprise networks. When partner services help enterprises address some of their network enterprise risks, this will help positively increase the relationship between the partner services and enterprises. The HPRE 120 allows partner services to proactively reduce risks in enterprises networks. For example, the longer issues remain in a network, the more troublesome it becomes over time. As such, the HPRE 120 adopts a proactive approach to address network issues and help partner services improve their performance.

The HPRE 120 is configured to learn and understand hierarchical relationships among enterprise assets, the enterprise network, and one or more network related partner services to calculate risk values. Risk values are indicative of the performance of network related partner services. For example, a low risk partner services are preferred by enterprises, whereas a high risk partner services may indicate that enterprises are likely to experience network related problems when using partner services.

Additionally, the HPRE 120 may calculate an overall partner services risk score that provides a benchmark for the partner services against other similarly situated partner services. While the partner services may stay the same, the overall partner services risk score and/or risk values may be modified based on actions of other similarly situated partner services. For example, the overall partner services risk score may increase because similarly situated partner services implemented additional measures to mitigate risks in their partner services. In other words, the overall partner services risk score and/or individual risk values in part are based on similarly situated partner services and their configuration actions in managing and supporting enterprise networks.

Moreover, the HPRE 120 provides visibility per individual risk metric (risk value) by showing how each risk value is individually calculated at a partner services level and an enterprise level. Enterprise level metrics can help determine individual issues faced by enterprises from various perspectives considering enterprise-unique criteria. For example, the HPRE 120 may indicate that a particular enterprise is not implementing a security related partner service exposing their network devices to a security threat. The risk values reflect partner services operations i.e., performance.

The HPRE 120 further generates actionable insights explaining where the partner services are in comparison to similar situated partner services as well as configuration actions in order to lower risk values. The actionable insights include guidance (e.g., a set of operations or task to perform in configuring enterprise networks) to lower risks to their similar but higher performing partner services. As such, the partner services may become more successful.

For example, explanations of an individual risk value for each performance category (such as a security risk category, a network device state risk category, a case support category, a licensing status risk category, etc.) is provided together with actionable insight(s) based on a fuzzy logic rules. Actionable insights may include recommendations and/or a set of configuration actions to be performed with respect to the enterprise networks. A set of configuration actions are one or more operations that changes one or more configurations in the enterprise networks and/or network devices. Actionable insights are specifically tailored to modify the individual risk value. For example, the HPRE 120 generates a list of configuration actions for partner services to perform using the cloud portal 100. In one example, at least some of the configuration actions may be performed by the HPRE 120 and/or the cloud portal 100 such as changing a configuration of a particular network asset, updating software asset to a newer version, resolving network issues of a particular enterprise, renewing expired software licenses, etc. The partner services are then notified that these automated configuration actions were performed.

While one or more example embodiments describe HPRE 120 with respect to the cloud portal 100, this is just an example. HPRE 120 may involve other services and systems. For example, HPRE 120 may directly interact with a network domain system, an enterprise system, etc. In other words, the HPRE 120 may or may not involve the cloud portal 100 for evaluating partner services risks in managing equipment and software of enterprises.

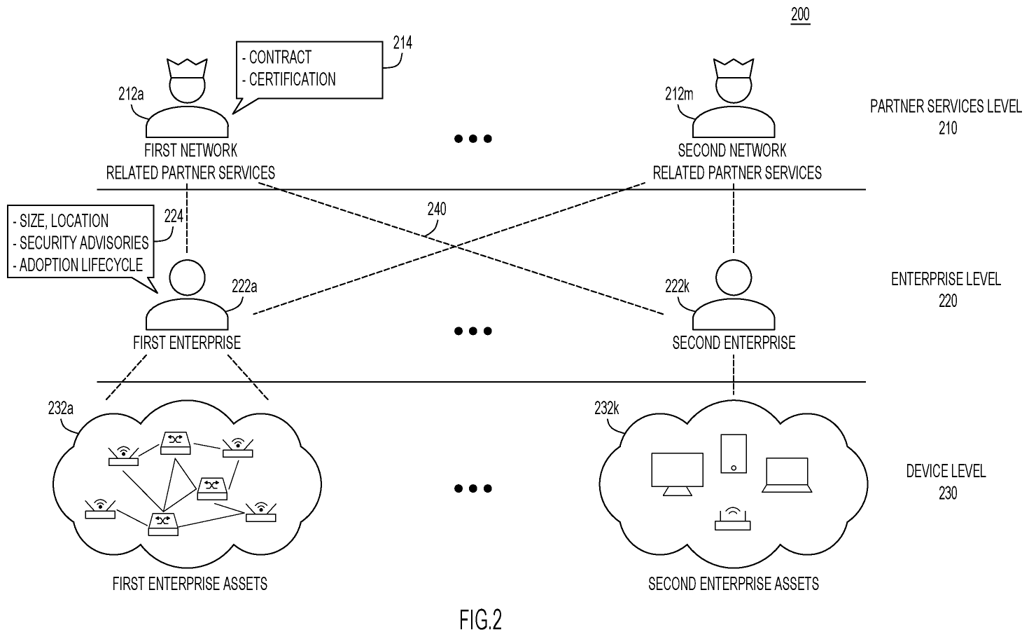

With continued reference to FIG. 1, FIG. 2 is a view illustrating hierarchical multiple relations 200 between partner services, network enterprises, and enterprise devices, which are learned by the HPRE 120 of FIG. 1, according to an example embodiment. The hierarchical multiple relations 200 involve a partner services level 210, an enterprise level 220, and a device level 230.

The partner services level 210 includes a plurality of network related partner services 212a-m such as a first network related partner services 212a provided by a first partner enterprise and a second network related partner services 212m provided by a second partner enterprise. Each network related partner services includes various attributes or characteristics, i.e., partner services level attributes 214. By way of an example, attributes of the first network related partner services 212a may include a distribution type, a certification type, contracts, enterprises being serviced, number and types of partner services being provided, etc. These are just some non-limiting examples of partner attributes.

The enterprise level 220 includes a plurality of enterprises 222a-k such as a first enterprise 222a and a second enterprise 222k. Each enterprise has its own distinct attributes and/or characteristics, i.e., enterprise level attributes 224. For example, attributes of the first enterprise 222a may include enterprise size, number of enterprise sites 110(1)-110(N) of FIG. 1, number and types of network/computing equipment and software 102(a)-102(N) of FIG. 1, geographic location(s), lifecycle stage(s) of various network technologies, security situations, number of open troubleshooting cases, etc.

The device level 230 includes a plurality of enterprise assets 232a-k such as first enterprise assets 232a of the first enterprise 222a and second enterprise assets 232k of the second enterprise 222k. Each set of enterprise assets also has its own distinct attributes. For example, the first enterprise assets 232a include network topology related information, types and number of network devices and network technologies (i.e., network/computing equipment and software 102(a)-102(N) of FIG. 1) at each enterprise site, etc.

As depicted at 240, each network related partner services may support multiple enterprises 222a-k and each enterprise may cooperate with multiple network related partner services 212a-m. Furthermore, each enterprise and network related partner services have individual distinct attributes to be considered. Moreover, enterprises may have complicated and diverse network structures. As such, evaluating partner risk metrics is not easy. Evaluating partner services involves an understanding of intricate hierarchical relationships between network devices, their configurations, enterprises, and network related partner services.

The HPRE 120 learns special properties (attributes and/or characteristics) of the plurality of enterprise assets 232a-k (enterprise networks), the plurality of enterprises 222a-k, and the plurality of network related partner services 212a-m including hierarchical relationships, shown at 240, to generate risk values, benchmark with similar entities, and provide actionable insights (suggestions) for optimization and improvement of network related partner services.

The HPRE 120 may provide the plurality of enterprises 232a-k with risk values of the plurality of network related partner services 212a-n. The HPRE 120 may provide to the plurality of network related partner services 212a-m their individual risk values and explanations that include a comparison to other similarly situated partner services. Noteworthy, explanations and configuration actions are provided to boost performance of the network related partner services and to modify their individual risk values (i.e., reduce risk metric) and/or their overall partner services risk score (i.e., increase overall rating).

The HPRE 120 determines and defines similarities between network related partner services and enterprises. That is, while evaluating network related partner services, there may be other network related partner services with similar conditions/attributes, which could help determine risk values of target network related partner services. Additionally, similarly situated enterprises may be helpful in determining risk values for the target network related partner services. A similarly situated enterprise network is an enterprise networks that shares one or more enterprise attributes with a target enterprise network. A similarly situated network related partner services are partner services that share one or more partner attributes with the target network related partner services. The enterprise level attributes 224 are different from the partner services level attributes 214.

To determine similarly situated network related partner services and enterprises, the HPRE 120 obtains enterprise data that includes attributes of enterprise assets and configuration of an enterprise network (enterprises), and partner data about attributes of network related partner services. The HPRE 120 analyzes the plurality of enterprise assets 232a-k, the plurality of enterprises 222a-k, and the plurality of network related partner services 212a-m using machine learning e.g., fuzzy deep learning and graph neural networks, to determine similarities. Attributes of enterprises and partner services are different (for example, security and product delivery), so two enterprises or two partner services who may be considered similar in one scenario (one attribute) may not be considered similar in another scenario (another attribute). Especially, due to data inconsistency because of management policy, purchased licenses, or other unique scenarios for each enterprise, there are differences in the similarity and completeness of data among enterprises, which makes it nearly impossible to directly use the enterprise's data and partner's data for clustering. As such, using machine learning, the HPRE 120 determines hierarchical multiple relations 200 among the plurality of enterprise assets 232a-k, the plurality of enterprises 222a-k, and the plurality of network related partner services 212a-m, and also evaluates various attributes to determine similarities between enterprises and/or similarities between network related partner services in various categories.

Moreover, the HPRE 120 may use auxiliary information from similar enterprises and partner services to calculate risk values and generate actionable insights for the target partner services. Auxiliary information may supplement gaps in the enterprise data and/or the partner data. The type and amount of auxiliary information depends on the enterprise and/or the target partner services. Some enterprises have sufficient enterprise data, and their status representations are relatively easy to extract. Thus, these enterprises can use less knowledge from similar situated enterprise and rely more on their own enterprise data. On the other hand, more auxiliary information may be useful for other enterprises whose representations are hard to extract. Therefore, the enterprise data may be adaptively fused with the auxiliary information.

The HPRE 120 also uses similarly situated partner services to provide actionable insights (configuration actions) such that the target partner services learns from its high-performing peers, or next-level peers to improved performance and decrease risks.

According to one or more example embodiments, the HPRE 120 provides an end-to-end framework to evaluate partner services risks among multiple enterprise and partner services based unique criteria while also considering learned hierarchical relationships. The HPRE 120 performs fuzzy clustering and graph neural network based deep learning to determine similar enterprises and partner services that provide auxiliary information to improve risk evaluation and generate enterprise and partner embeddings.

In one or more example embodiments, the HPRE 120 performs an information attention fusion to automatically assign weights to partner services, enterprises (enterprise network and assets), and auxiliary information of similar situated enterprises and/or partner services, which identifies amounts of auxiliary information for each individual risk value, which together forms an overall partner services risk score. The HPRE 120 generates a model based on an adaptive neuro-fuzzy inference system (ANFIS) that calculates an overall partner risk score and interpretable fuzzy rules to help partner services understand the logic behind the overall partner risk score and/or risk values. The HPRE 120 may provide or implement configuration actions for a selected group of enterprises based on issues and behaviors from similarly situated but lower-risk partner services, to mitigating network risks and improve partner services' performance.

With continued reference to FIGS. 1 and 2, FIG. 3 is a block diagram illustrating components of the HPRE 120 of FIG. 1, according to an example embodiment. The HPRE 120 includes an enterprise data embedding component 310, a partner data embedding component 320, and a machine learning and recommendation component 330 that uses auxiliary information 340 and knowledge base 350, to generate risk values and actionable insights.

The enterprise data embedding component 310 and the partner data embedding component 320 perform embedding of enterprise data and partner data, respectively, in a high-dimensional representation. In the meantime, auxiliary information 340 based on similarly situated enterprises and network related partner services, is generated while considering hierarchical relationships and various attributes of enterprises and/or partner services.

Specifically, the enterprise data embedding component 310 obtains enterprise data 312, which includes device data about a plurality of enterprise assets and configuration of the enterprise network (i.e., a network topology 314) and an enterprise profile 316. The enterprise profile 316 includes enterprise level attributes (e.g., enterprise level attributes 224) such as size of an enterprise, location of the enterprise, number of enterprise sites, number and types of security advisories, state of network technologies (stage(s) in the adoption lifecycle), tenure within the cloud portal 100 (amount of time partner services were used).

The network topology 314 and the enterprise profile 316 are used to generate an enterprise embedding 318. That is, data about a single enterprise network is embedded based on enterprise level attributes and the enterprise network. Because an enterprise may belong to multiple categories (multi-category risk evaluation 319), a fuzzy-based clustering method is deployed to determine probability that an enterprise belongs in various clusters instead of traditional hard clustering methods. Moreover, the relationship between closer clusters may be captured by a graph neural network. Auxiliary information, in a form of a similarly situated enterprise embedding, is selected from a centroid node representation to which the target enterprise belongs. In addition to the enterprise embedding 318 and its auxiliary information, the multi-category risk evaluation 319 is generated with respect to the enterprise.

The partner data embedding component 320 obtains enterprise embeddings 322a-j (e.g., a single enterprise embedding—the enterprise embedding 318 and similarly situated enterprise embeddings). In one example embodiment, the partner data embedding component 320 obtains managed enterprises aggregated embedding (i.e., an embedding that aggregates enterprise embeddings of the enterprises that use the network related partner services).

The partner data embedding component 320 further obtains partner data 324. The partner data 324 includes information about partner related network services including partner profile and partner services level attributes 214 of FIG. 2. Like the enterprise data embedding component 310, the partner data embedding component 320 generates partner data embedding 326 but without generating risk categories for the partner services. The partner data embedding component 320 further generates similarly situated partner data embeddings. The partner data embedding component 320 generates partner data embeddings 328a-i.

The machine learning and recommendation component 330 uses a fuzzy logic-based deep learning partner analyzing model 332 to generate partner services performance evaluations (partner performance analyzing 334) and actionable insights (enhancement suggestions 336).

The fuzzy logic-based deep learning partner analyzing model 332 analyzes the partner data embedding 326 and similarly situated partner data embeddings (auxiliary information) to determine multi-category partner services risk values, an overall partner services risk score and to generate various explanations for the risk values and actionable insights for modifying the risk values. The machine learning and recommendation component 330 evaluates partner services risks and infers suggestions from a fuzzy logic-based deep learning partner analyzing model 332 based on the plurality of enterprise embeddings 322a-j, the plurality of partner data embeddings 328a-i and external resources i.e., the auxiliary information 340 and the knowledge base 350.

The auxiliary information 340 involves similar enterprise embeddings 342a-h and similarly situated partner data embeddings to generate an enhanced partner data embedding 346. The auxiliary information 340 includes at least one other enterprise network that shares one or more attributes with the target enterprise network. The auxiliary information 340 further includes other network related partner services that share the one or more attributes with the target network related partner services. The fuzzy logic-based deep learning partner analyzing model 332 determines among of the auxiliary information 340 to use by assigning various weights.

The knowledge base 350 includes various data sources. The data sources are data and information systems such as advisory information systems, electronic learning (e-learning) libraries, product guidance and documentation, support case management platforms, community forums, third party vendors, and content management systems. By way of an example, the knowledge base 350 includes learning materials 352a, product specification 352b, and offers 352c (licensing and upgrade features).

In one example embodiment, all four types of data embeddings (single enterprise embedding, similar enterprise embeddings, single partner data embedding, and similar partner data embeddings) are input into the fuzzy logic-based deep learning partner analyzing model 332. Then, the fuzzy logic-based deep learning partner analyzing model 332 determines the amount of auxiliary information to be considered when determining a respective risk value for each sub-domain or category (such as a security category, enterprise service satisfaction category, network technology integration category, licensing status category, etc.), using information attention fusing. The fuzzy logic-based deep learning partner analyzing model 332 generates partner performance analyzing 334 with individual risk values for categories. The fuzzy logic-based deep learning partner analyzing model 332 may further determine an overall partner services risk score for target partner services.

The fuzzy logic-based deep learning partner analyzing model 332 includes a neural-fuzzy-logic-based model to identify explainable and interpretable fuzzy rules that help partner services know where they stand compared with peers (similarly situated partner services) and to help them modify their risk values and/or overall partner services risk score by progressing to the next level (improving). The fuzzy logic-based deep learning partner analyzing model 332 generates enhancement suggestions 336 for the target enterprise services.

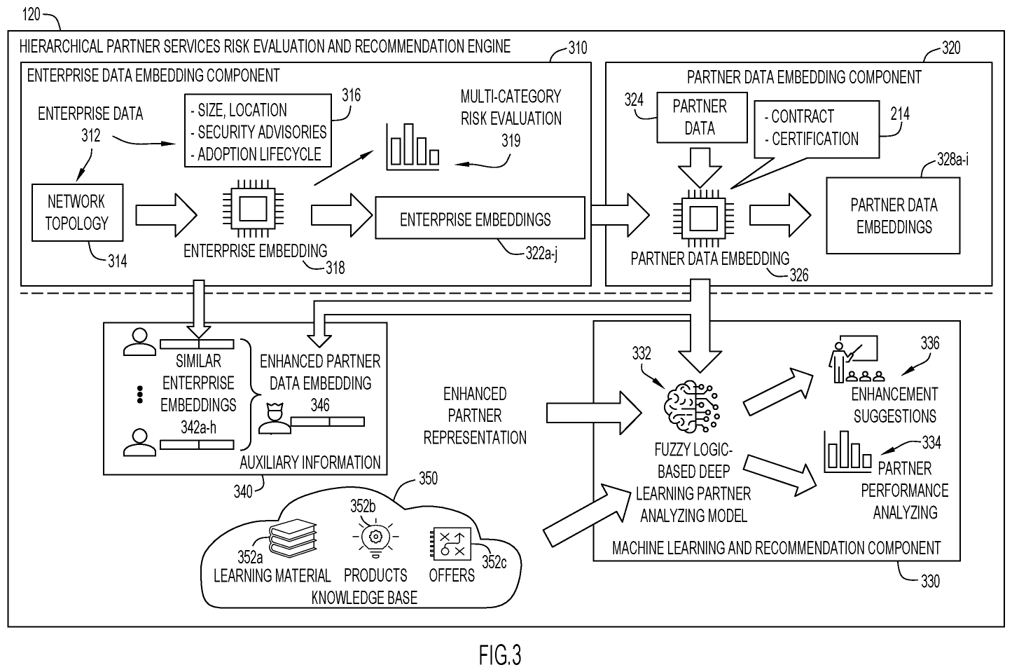

With continued reference to FIGS. 1-3, FIG. 4 is a diagram illustrating an embedding process 400 in which the HPRE 120 generates enterprise data embeddings 322a-j of FIG. 3 and partner data embeddings 328a-i of FIG. 3, according to an example embodiment. The embedding process 400 involves the enterprise data embedding component 310 of FIG. 3 and the partner data embedding component 320 of FIG. 3.

The embedding process 400 involves extracting and embedding the enterprise data 312 of FIG. 3 to generate a single enterprise embedding 420 and similarly situated enterprise embeddings (shows as clusters 440a-h). The embedding process 400 further involves extracting and embedding the partner data 324 of FIG. 3 to generate a single partner services data embedding 460 and similarly situated partner services data embeddings.

To determine similarly situated enterprises and partner services, the embedding process 400 uses fuzzy clustering. Traditional clustering identifies similar objects from a given dataset. Although clustering is effective in various applications and scenarios, it fails in complicated or complex scenarios such as when the hierarchical multiple relations 200 of FIG. 2 are involved.

For example, if two enterprises have one and five security advisories, respectively, and the security advisories are regarding distributed denial-of-service (DDOS) attacks. Theoretically, both enterprises should belong to the same clusters since they have the same type of risk. However, the traditional clustering method will assign the enterprises to two different clusters because either the number of security advisories between these two enterprises is not the same (one security advisory versus five security advisories) or one hot encoding will occur if an enterprise is affected by one security advisory and the enterprises have different security advisories. Moreover, due to the inconsistency in enterprise data because of management policy, purchased licenses, or other unique scenarios, there are differences in the similarity and completeness of the data among enterprises, which makes it nearly impossible for direct clustering. As such, the embedding process 400 uses a deep learning approach of applying graph neural network (GNN) and fuzzy clustering to improve performance of similarity evaluations between enterprises, in which similar enterprise embedding could also be utilized as auxiliary information 340 of FIG. 3.

The embedding process 400 involves at 472, extracting enterprise profile 402 from the enterprise data 312. The enterprise profile 402 includes a user role (e.g., IT specialist role), enterprise type, size, number of enterprise sites, leadership (control center), number and type of assets at each enterprise site, number of employees, etc. At 474, a user profile embedding 404 is generated based on the enterprise profile 402.

In one example embodiment, each enterprise profile information includes self-explanatory data that can be used as input to generate the user profile embedding 404 such as the role of this user in the cloud portal 100 of FIG. 1, the category of the enterprise, the location of the equipment in charge, etc. To make the data interpretable, feature engineering is employed on the enterprise profile 402 to obtain the user profile embedding 404. If the feature within the data is a number, the embedding process 400 directly uses its numerical embedding. On the other hand, if the feature is categorical (e.g., type of enterprise), one-hot embedding is conducted on the feature.

At 476, enterprise network topology 406 is extracted from the enterprise data 312. The enterprise network topology 406 includes information about the assets and configuration of the enterprise network. The enterprise network topology 406 may be complicated and cannot be directly embedded. Since each enterprise network is complicated with various types of assets (network devices, network technologies, connections, etc.), a graph neural network is employed.

Specifically, at 478, the graph neural network generates a network embedding 408 based on the enterprise network topology 406. Using graph neural network is especially beneficial for complex network graph data where the nodes within the graph neural network represent features of each network device (enterprise asset) and edges represent the connectivity between the network devices. At 480, the user profile embedding 404 and the network embedding 408 are concatenated together to form a single enterprise embedding 420.

The embedding process 400 further includes fuzzy clustering of enterprise embeddings to form the clusters 440a-h of similarly situated enterprise embeddings in various categories. By way of an example, a single enterprise may belong to multiple clusters in a real-world situation such as an enterprise that provides service and resells products at the same time.

Using fuzzy clustering method, similar enterprises are determined for the target enterprise. Specifically, at 482, the single enterprise embedding 420 is includes in a first cluster category 430a (low number of security alerts) and a second cluster category 430b (low number of open troubleshooting cases). The single enterprise embedding 420 is not includes in other clusters from the cluster categories 430a-e based on feature/attribute analysis. Instead of using hard clustering methods where one enterprise could belong to one cluster, fuzzy clustering is used.

When performing fuzzy clustering on the single enterprise embedding 420, there may be interactions between cluster categories 430a-e where cluster topics are similar to each other. For instance, if there is a small cluster size and enterprises are grouped into precise clusters, some clusters close to each other have comparable characteristics and it is important to capture these interactions. Therefore, at 484, another graph neural network is used to capture the inter-cluster relationships on the K-nearest centroid graph generated from the fuzzy clustering at 482. By applying graph neural networks, the plurality of clusters 440a-h are generated. Each cluster represents enterprises that share one or more attributes (e.g., similar enterprise profiles, similar types of security alerts, similar network configuration features A, B, and C on the enterprise networks, etc.).

The embedding process 400 generates the single enterprise embedding 420 along with its auxiliary information that include similarly situated enterprise embeddings (clusters 440a-h). Additionally, as is visible from the clusters 440a-h, the embedding process 400 generates multi-category risk evaluations based on the enterprise embeddings to determine risk values for each category.

At 486, the single enterprise embedding 420 and similarly situated enterprises (enterprise auxiliary information) are input into machine learning 450 (neural network) and at 488, enterprise performance data 452 for various risk categories is generated i.e., the multi-category risk evaluation 319 of FIG. 3. Some examples of the categories in risk evaluation may include potential attacker threat, loss of service, data breach, slowdown of service, network stability, coverage, and other network risks within the enterprise. These categories may be evaluated on a numeric scale such as on a scale of 0 to 100. The enterprise performance data 452 may be individual risk values of the clusters 440a-h.

Additionally, at 490, the single enterprise embedding 420 and auxiliary information (the clusters 440a-h) along with the partner data 324 are used to generate the single partner services data embedding 460. That is, the embedding process 400 for generating the single partner services data embedding 460 is similar to generating the single enterprise embedding 420 while inputs and outputs are different compared to the single enterprise embedding 420.

Specifically, input includes the partner data 324 that identifies partner services (e.g., user profile, type of services provided, number of enterprises being serviced, etc.). The input further includes the single enterprise embedding 420 for each enterprise associated with the partner services (i.e., each enterprise being serviced or managed by one or more network related partner services of the partner enterprise). The input further includes auxiliary information of each managed enterprise. The output is the single partner services data embedding 460 and similarly situated partner services data embeddings (not shown), referred to as similar partner services data embeddings. The four types of generated embeddings are provided as input to machine learning and recommendation component 330 of FIG. 3 to perform partner risk evaluations.

With continued reference to FIGS. 1-4, FIG. 5 is a diagram illustrating a fuzzy logic based deep learning process 500 performed by the machine learning and recommendation component 330 of FIG. 3, according to an example embodiment. The machine learning and recommendation component 330 includes two subcomponents: an information attention fusion subcomponent 510 and a deep neural fuzzy logic subcomponent 530.

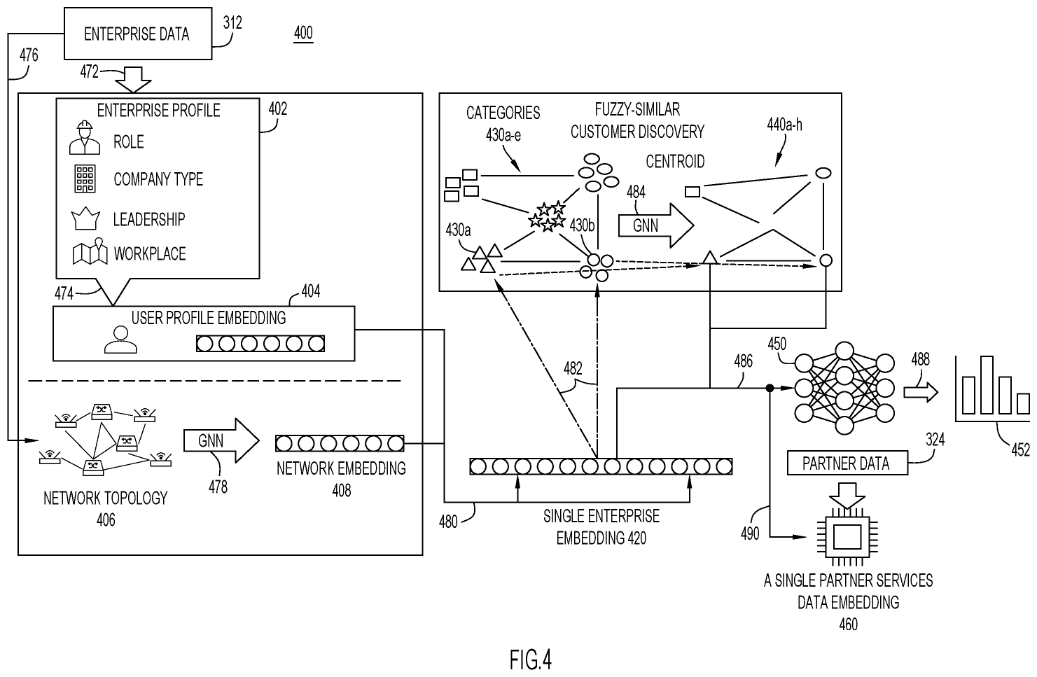

The information attention fusion subcomponent 510 obtains input from the embedding process 400 of FIG. 4. The input includes a single enterprise embedding 502 (a target enterprise embedding), a similar enterprise embedding 504 (enterprise auxiliary information obtained from similarly situated enterprises), a single partner services data embedding 506, and a similar partner services data embedding 508 (partner services auxiliary information obtained from similarly situated partner services). The information attention fusion subcomponent 510 determines amount of auxiliary information to use based on attention weights 512a-d and generates an enhanced partner services data representation 514 (the enhanced partner data embedding 346 of FIG. 3). The enhanced partner services data representation 514 includes information about partner services for categories 516a-c such as a security category 516a, an aging category 516b, and a performance category 516c.

The security category 516a includes security related attributes such as number of security alerts, number of detected vulnerabilities in the enterprise networks serviced by the partner services, number of vulnerable network devices, etc. The aging category 516b includes aging related attributes such as age of various network devices, versions of the software being used, age of enterprise network configurations, latest updates and upgrades, licensing status (expired licenses), etc. The performance category 516c includes performance related attributes such as number of open cases, network connectivity issues, enterprise network speed, compute power of enterprise assets, etc. These are just some non-limiting examples of the plurality of categories 516a-c and attributes analyzed by the HPRE 120. The type and number of attributes and categories depend on a particular deployment and use case scenario.

The deep neural fuzzy logic subcomponent 530 includes a plurality of layers 532a-c. The plurality of layers 532a-e include an input layer 532a that obtains the enhanced partner services data representation 514 and splits data into sets by categories 516a-c, a membership layer 532b that assigns membership degrees to each input data set, a fuzzification layer 532c that converts the input data into fuzzy data sets, a normalization layer 532d that normalizes the firing strength of each rule, and defuzzification layer 532e that converts the output from normalization layer 532d into risk values 534a-x and/or fuzzy rules (explanations). The firing strength is a measure of how much each rule contributes to the overall output of the model. The normalization layer is used to ensure that all the rules have the same weight, which helps to improve the stability of the ANFIS model.

The fuzzy logic based deep learning process 500 involves at 550, obtaining input embeddings (the single enterprise embedding 502, the similar enterprise embedding 504, the single partner services data embedding 506, and similar partner services data embedding 508). The input embeddings are used to perform a multi-category risk determinations.

Specifically, at 552, attention weights 512a-d are assigned to each embedding to extract the proper amount of data from the auxiliary information. The amount of auxiliary information is determined using the attention weights 512a-d. For example, if the single enterprise embedding 502 is deficient (no data or little data for the security category 516a), a higher attention weight is assigned to the similar enterprise embedding 504. That is, the single enterprise embedding 502 is fused or complemented with auxiliary information based on the deficiency and/or lack of information. Similarly, partner services auxiliary information is used to supplement the single partner services data embedding 506. The partner auxiliary information and partner services are also fused together.

At 554, the enhanced partner services data representation 514 is generated by fusing the embeddings using the attention weights 512a-d. The enhanced partner services data representation 514 is a comprehensive partner representation that includes various attributes for the categories 516a-c.

At 556, the enhanced partner services data representation 514 is input into the input layer 532a of the deep neural fuzzy logic subcomponent 530. That is, instead of creating a model that only evaluates and outputs a risk value using a neural network, the deep neural fuzzy logic subcomponent 530 generates and provides multiple risk values for various categories including explanations so that the target partner services may understand the meaning of the individual risk values and how to modify these risk values to improve their performance. Specifically, the deep neural fuzzy logic subcomponent 530 uses the adaptive neuro-fuzzy inference system (the ANFIS) based on neural networks and fuzzy inference to generate the risk values 534a-x and explanations thereof. The ANFIS is a powerful tool for modeling and controlling complex systems and is incorporated into the fuzzy logic-based deep learning partner analysis. ANFIS is easy to use and is trainable with relatively little data and may improve performance of many systems.

At the input layer 532a, the enhanced partner services data representation 514 is split into data sets by categories 516a-c. At 558, the split data sets are provided to the membership layer 532b, which assigns various membership degrees to each input data set.

At 560, the output is provided into the fuzzification layer 532c. The fuzzification layer 532c converts the data sets into fuzzy sets that provide fuzzy rules (i.e., explanations) for the risk values 534a-x.

At 562, the fuzzification layer 532c provides the fuzzy sets to the normalization layer 532d, which normalizes the firing strength of each fuzzy rule and at 564, outputs the normalized fuzzy rules to the defuzzification layer 532e. The defuzzification layer 532e converts the fuzzy rules from the normalization layer 532d into a risk values 534a-x with explanations in the form of these fuzzy rules. That is, each rule has a fuzzy condition, which is a collection of fuzzy membership functions that indicate the extent that the input data meets the condition, and a fuzzy conclusion, which is a fuzzy membership function that represents the degree to which the output data satisfies the conclusion. At 566, the risk values 534a-x with explanations are output and/or provided to the target partner services.

According one or more example embodiments, the machine learning and recommendation component 330 uses the fuzzy logic-based deep learning partner analyzing model 332 that obtains inputs of various embeddings and auxiliary information and outputs an overall partner services risk score, which may be an aggregation of risk values 534a-x with various weights and a set of explainable fuzzy rules.

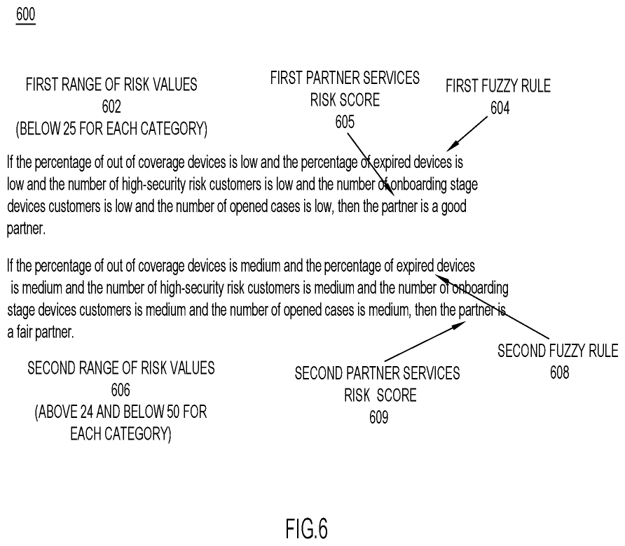

With continued reference to FIGS. 1-5, FIG. 6 is a view illustrating fuzzy rules 600 generated by the machine learning and recommendation component 330, according to an example embodiment. The fuzzy rules 600 includes a first range of risk values 602, a first fuzzy rule 604, a first partner services risk score 605, a second range of risk values 606, a second fuzzy rule 608, and a second partner services risk score 609.

The first range of risk values 602 indicates that the partner services are low risk partners e.g., risk values below 25 for each category or a set of categories. The first fuzzy rule 604 provides an explanation for the first range of risk values 602. For example, the first fuzzy rule 604 indicates that the partner services are good (e.g., a first partner services risk score 605). The first fuzzy rule 604 further explains that (a) the percentage of out of coverage network devices of the enterprise network is low and (b) the percentage of expired network devices is low (e.g., state of network devices category). The first fuzzy rule 604 further explains that (c) the number of high-security risk enterprises (a first partner services attribute) is low and (d) the number of network devices is an onboarding state is low (e.g., state of the enterprise network devices category-second partner services attribute). Moreover, the first fuzzy rule 604 may further explain that (e) the number of open cases is low (e.g., state of the enterprise network connectivity category-a third partner services attribute). These are just some non-limiting examples of fuzzy rules for risk values. The first range of risk values 602 indicate that the target partner services are low risk and their performance is high.

The second range of risk values 606 is above 24 but below 50 for each category or a set of categories. The second fuzzy rule 608 provides an explanation for the second range of risk values 606. For example, the second fuzzy rule 608 indicates that the partner services are fair (e.g., a second partner services risk score 609). The second fuzzy rule 608 explains that (a) the percentage of out of coverage network devices of the enterprise network is medium and (b) the percentage of expired network devices is medium. The second fuzzy rule 608 further explains that (c) the number of high-security risk enterprises is medium and (d) the number of network devices is an onboarding state is medium. The second fuzzy rule 608 further explains that (e) the number of open cases is low. These are just some non-limiting examples of fuzzy rules for the risk values. The second partner services risk score 609 is medium as indicated by “the partner is fair”. That is, the partner services are medium risk and performance of the partner services is acceptable or fair.

With continued reference to FIGS. 1-6, FIG. 7 is a diagram illustrating a method 700 of improving partner services performance based on a partner services risk evaluations, according to an example embodiment. The method 700 is performed by HPRE 120 or FIGS. 1-5. The method 700 involves target partner services 702, inference rules 704, auxiliary information about similarly situated partner services 706, a knowledge base 708, and actionable insights 709.

The method 700 involves at 710, generating or extracting an enhanced partner services representation using features from the target partner services and its similarly situated peers, its managed enterprises, and similarly situated enterprises. That is, at 710, the embedding process 400 of FIG. 4 is performed.

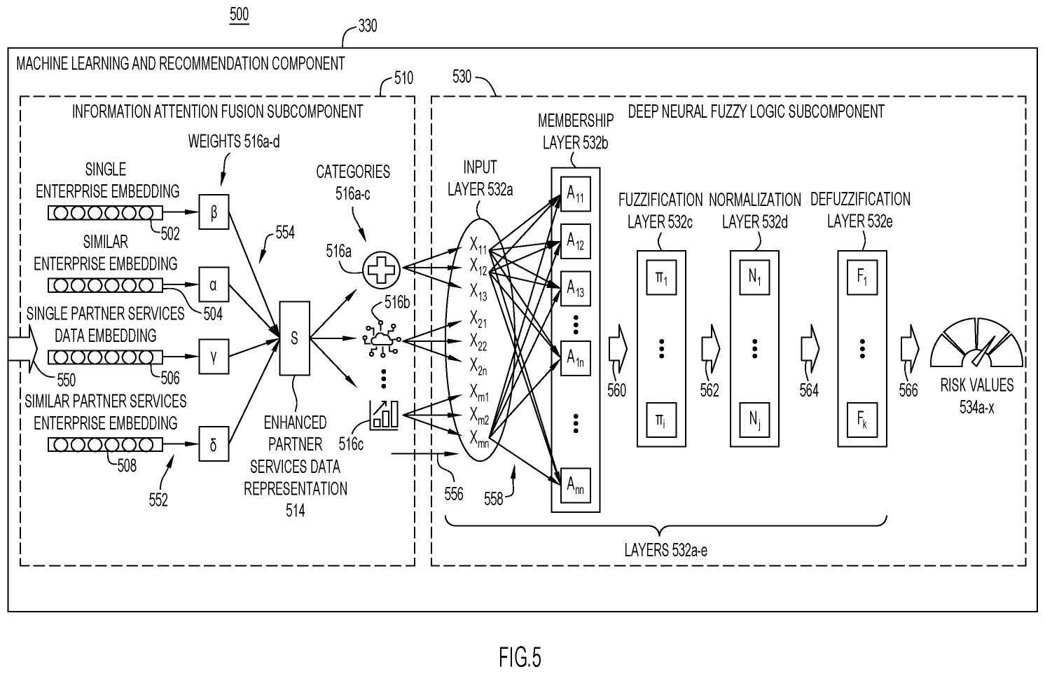

At 712, evaluation and inference is performed based on the enhanced partner services representation. That is, a plurality of risk values are determined using the machine learning and recommendation component 330 of FIG. 3. The deep learning process 500 of FIG. 5 is performed to generate the inference rules 704, which include explanations of the determined risk values. The inference rules 704 may include that the first risk value is calculated based on network devices coverage, the second risk value is calculated based on number of network assets that are stuck at an onboarding state.

At 714, the risk values with inference rules 704 may be provided to the target partner services 702. Specifically, for each condition within a fuzzy rule that the target partner services 702 do not align with, a group of its managed enterprises with similar network related issues are selected and prioritized while also considering the similarity from enterprise embeddings of the target partner services 702.

At 716, the HPRE 120 may further generate the actionable insights 709. The actionable insights 709 include suggestions, recommendations, configuration actions, etc. For example, the actionable insights 709 may include configuration actions for a selected group of enterprises based on the network issue and behaviors from similar but lower-risk partner services selected from the similarly situated partner services 706. The similarity between partner services is determined by using the similarly situated partner embeddings extracted at 710. At the same time, healthy partner services that are not similar to current partner services, such as partners with higher-level certificates, can also recommend corresponding activities through the HPRE 120 to help the improvement of the current enterprise. The knowledge base 708 is used to generate the actionable insights 709.

At 718, the target partner services 702 are provided with actionable insights 709 to improve performance of target partner services 702 and/or to improve the network or their managed enterprises' networks. The partner services may then decide to incorporate the actionable insights 709 (i.e., adoption). In one example embodiments, the HPRE 120 may perform various configuration actions with respect to enterprise networks automatically. The data for the target partner services 702 is then updated based on the configuration actions, providing a feedback loop.

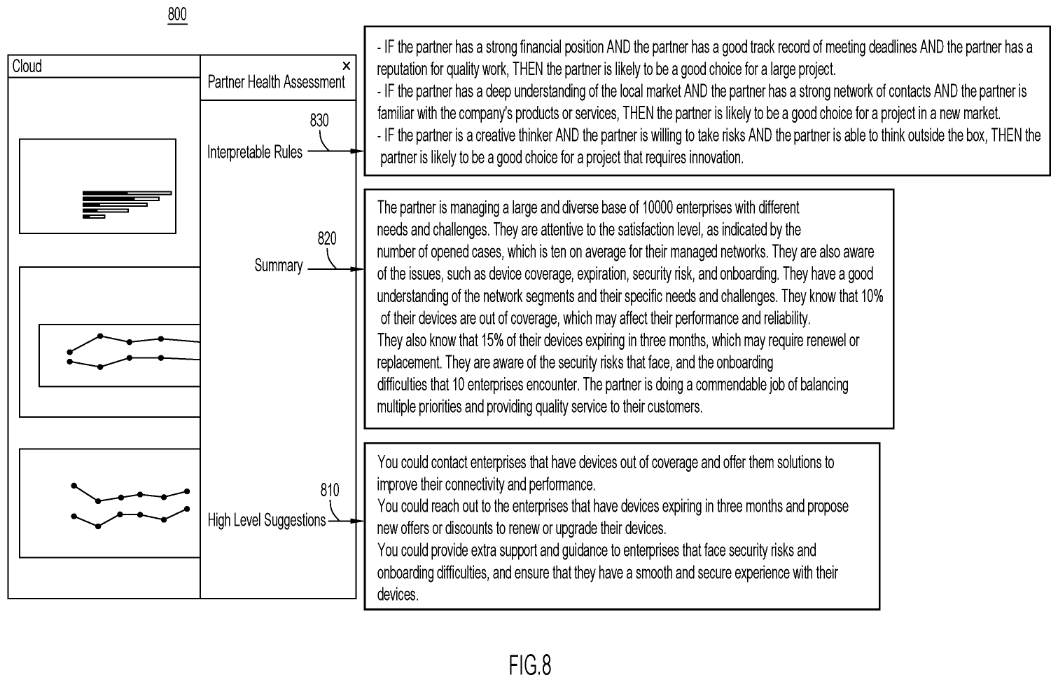

With continued reference to FIGS. 1-7, FIG. 8 is a view illustrating a user interface 800 that provides risk values indicative of the performance of partner services together with explanations and actionable insights, according to an example embodiment. The user interface 800 includes a high-level suggestions 810 of target network related partner services, a summary 820 of the target network related partner services, and interpretable rules 830 for understanding the summary 820.

The high-level suggestions 810 may include various configuration actions that should be performed to improve performance of target network related partner services. For example, the high-level suggestions 810 may include upgrade out of coverage network assets of enterprises A. B, and C to improve their enterprise network connectivity and performance. As another example, update licensing status for software XXXX in enterprise networks A, C, and D. As yet another example, a notification may be provided that the HPRE 120 onboarded network devices 1, 2, and 3 in the enterprise network C. The high-level suggestions 810 may include more detailed information about each issue being generated such as the affected enterprises for a health-related issue, enterprises' devices that expire after a certain time, etc.

The summary 820 may include an overall partner services risk score for the target network related partner services such as “80” for a good partner. The summary 820 may further include individual risk values for various categories. That is, the summary 820 provides an overall evaluation score and details based on the evaluation of sub-categories. The summary 820 is indicative of current performance and/or state of target network related partner services.

The interpretable rules 830 may be in a form of a list that provide explanations for the risk values. That is, interpretable rules 830 explain why the target network related partner services is in the current rating(s).

According to one or more example embodiments, the HPRE 120 helps target network related partner services to obtain an overall partner services risk score, interpretative rules regarding the risk score, a summary of their current situation, and/or suggested actionable insights to tackle the enterprise networks risks based on their managed enterprises' networks and partner data. The HPRE 120 uses enterprise data, auxiliary enterprise information of similarly situated enterprises derived using graph neural network and fuzzy clustering, and a multi-category risk evaluation based on the enterprise embeddings. Moreover, partner data and the aggregated embedding of managed enterprises (partner data) and along with partner services auxiliary information is fed into a fuzzy logic-based deep learning to generate an overall partner services risk score and interpretive rules that were used to calculate the risk score. Lastly, actionable insights are generated for both the partner services and managed enterprises to improve overall risk in their enterprise networks and to improve performance of partner services.

For example, partner services oversees risk between managed enterprise networks. For example, partner services A manages 20+ enterprise networks may ensure that their network devices are onboarding seamlessly and the enterprise networks are providing the connectivity. However, for partner services to ensure that enterprises are manage their enterprise networks is to check each enterprises cloud portal (network management platform) and observe the enterprise network, which can be tedious, time consuming, and error prone. In addition, since each enterprise has different features within their enterprise network, it is hard to evaluate network risks based on each different enterprise network scenario.

Using the HPRE 120, the partner services A has access to an overall risk score among their own enterprise and managed enterprise networks so that they are aware of any network issues. The score is a tailored assessment based on the partner's enterprise and their managed enterprise networks. In addition, the partner services A have interpretable rules 830 regarding the formulation of the overall risk score and/or individual risk values (the summary 820), and an action plan (the high-level suggestions 810). The partner services A can thus help its enterprises to lower network risks and improve their own performance.

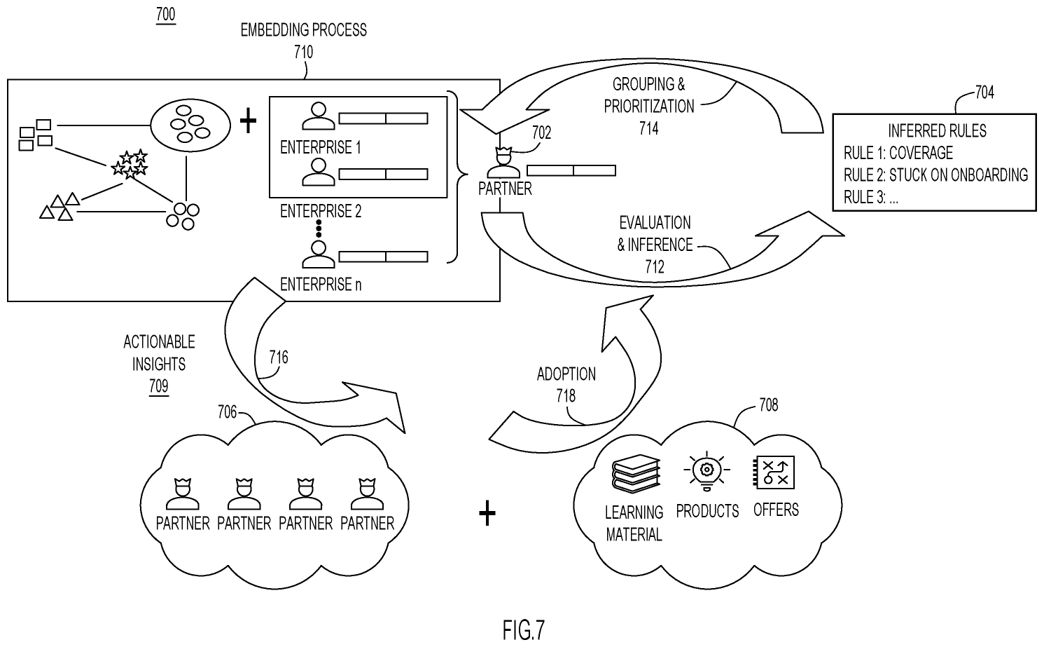

As yet another example, network related partner services B coordinate risk action plans. For example, network related partner services B manages 50+ enterprise networks and wants to be proactive and figure out how their managed enterprise networks are performing security-wise so that their network is secure. However, with so many enterprise networks to manage, it is very hard to review each enterprise network and determine which ones to prioritize to minimize the number of security risks among the managed enterprise networks. Using the HPRE 120, the network related partner services B understands the security risks within their partner services and their managed enterprise networks and obtains a detailed explanation of the risks. Also, the network related partner services B can take the next steps to lower the overall risk and individual risk values by examining the high-level suggestions 810 and tackling network risk by importance (prioritization at 714 of FIG. 7).

The techniques presented herein provide the HPRE, which generates an end-to-end framework to analyze partner risk among multiple enterprise and partner services based unique criteria while also considering their hierarchical relationships. The HPRE employs a fuzzy clustering and graph neural network-based deep learning to determine similarly situated enterprises and similarly stated partner services that provide auxiliary information to improve risk evaluation analysis. The HPRE further employs an information attention fusion component that generates and assigns attention weights to partner services data, enterprise data, and auxiliary information of similarly situated enterprises and partner services, to determine amounts of information to adopt for individual risk values that form the overall partner services risk score.

The HPRE further uses an adaptive neuro-fuzzy inference system (ANFIS) that generates risk values along with interpretable fuzzy rules to help partner services understand the logic behind the risk values and/or the overall partner services risk score. The HPRE may execute various actions or configuration operations based on the risk evaluation or may generate specific suggested sequential configuration actions (action plan) for a selected group of enterprise networks based on issues and behaviors from similarly situated but lower-risk partner services. The HPRE provides the next steps to mitigating network risk.

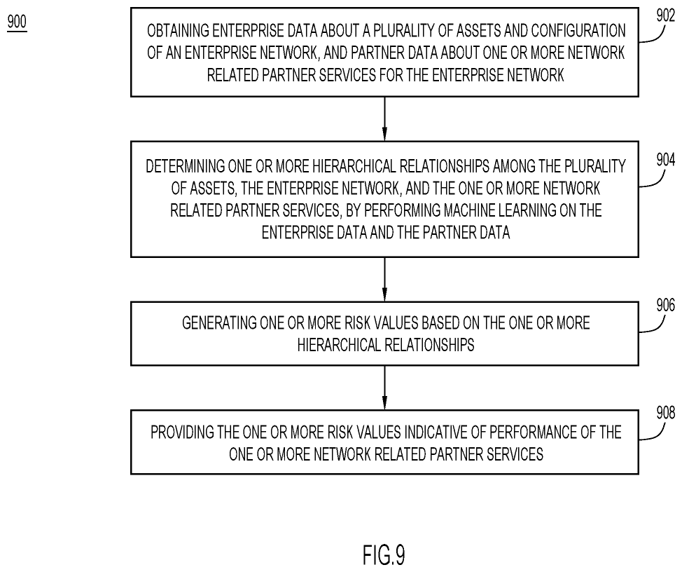

FIG. 9 is a flowchart illustrating a method 900 of providing one or more risk values that are indicative of performance of one or more network related partner services, according to an example embodiment. The method 900 may be performed by a computing device such as a server or a group of servers that execute the hierarchical partner services risk evaluation engine (the HPRE 120) of FIGS. 1-8.

The method 900 involves, at 902, obtaining enterprise data about a plurality of assets and configuration of an enterprise network, and partner data about one or more network related partner services for the enterprise network.

The method 900 further involves at 904, determining one or more hierarchical relationships among the plurality of assets, the enterprise network, and the one or more network related partner services, by performing machine learning on the enterprise data and the partner data.

Additionally, the method 900 involves at 906, generating one or more risk values based on the one or more hierarchical relationships and at 908, providing the one or more risk values indicative of performance of the one or more network related partner services.

In one form, the method 900 may further include performing at least one configuration action to the enterprise network based on one or more configuration actions performed by a plurality of similarly situated network related partner services to modify the one or more risk values.

In another form, the operation 906 of generating the one or more risk values may include generating a respective risk value and an explanation for the respective risk value for each of a plurality of performance categories including one or more of a security risk category, a network device state risk category, a case support category, and a licensing status risk category.

According to one or more example embodiments, the method 900 may further include generating at least one actionable insight for a respective risk value based on a fuzzy rule in which one or more of a similarly situated enterprise or similarly situated network related partner services are considered. The at least one actionable insight includes one or more configuration actions for the enterprise network.

In one instance, the method 900 may further involve generating an enterprise data embedding based on the enterprise data. The enterprise data embedding may be based on an enterprise profile that includes one or more attributes of an enterprise and may further be based on a network topology embedding generated using a graph neural network of the plurality of assets and the configuration of the enterprise network. The one or more hierarchical relationships may be determined based on the enterprise data embedding.

In another instance, the method 900 may further include generating a partner data embedding based on a network related partner services enterprise profile and information about the one or more network related partner services provided to a plurality of enterprises. The one or more hierarchical relationships may be determined based on the partner data embedding.

According to one or more example embodiments, the operation 904 of determining the one or more hierarchical relationships by performing the machine learning may include performing a graph neural network-based deep machine learning of the enterprise data and the partner data to learn the one or more hierarchical relationships between the plurality of assets, the enterprise network, and the one or more network related partner services.

In one form, the method 900 may further include determining at least one similarly situated enterprise network that shares one or more attributes with the enterprise network and similarly situated network related partner services that share the one or more attributes with the one or more network related partner services, by performing fuzzy based clustering. The operation 906 of determining the one or more risk values may further be based on the at least one similarly situated enterprise network and the similarly situated network related partner services.

In another form, the method 900 may further involve determining auxiliary information about at least one other enterprise network that shares one or more attributes with the enterprise network and other network related partner services that share the one or more attributes with the one or more network related partner services. The operation 906 of determining the one or more risk values may further be based on the auxiliary information.

According to one or more example embodiments, the method 900 may further involve determining an amount of the auxiliary information based on the enterprise data and the partner data and fusing the enterprise data and the partner data with the amount of the auxiliary information to determine the one or more risk values.

In one instance, the method 900 may further include generating a partner services risk score and one or more explanations for the partner services risk score by performing adaptive neuro-fuzzy inference machine learning of the enterprise data, the partner data, and the auxiliary information. The partner services risk score may be indicative of the performance of the one or more network related partner services with respect to the other network related partner services.

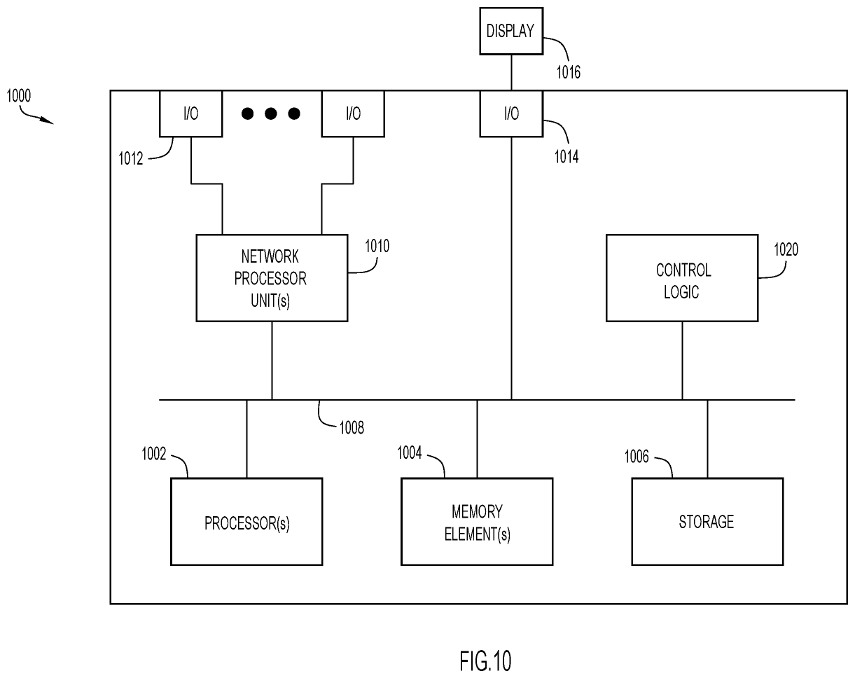

FIG. 10 is a hardware block diagram of a computing device 1000 that may perform functions associated with any combination of operations in connection with the techniques depicted in FIGS. 1-9, according to various example embodiments, including, but not limited to, operations of the computing device or one or more servers that execute the cloud portal 100 and/or the HPRE 120 and/or the component of HPRE 120. Further, the computing device 1000 may be representative of one of the network devices, network/computing equipment, or hardware asset of an enterprise. It should be appreciated that FIG. 10 provides an illustration of one example embodiment and does not imply any limitations with respect to the environments in which different example embodiments may be implemented. Many modifications to the depicted environment may be made.

In at least one embodiment, computing device 1000 may include one or more processor(s) 1002, one or more memory element(s) 1004, storage 1006, a bus 1008, one or more network processor unit(s) 1010 interconnected with one or more network input/output (I/O) interface(s) 1012, one or more I/O interface(s) 1014, and control logic 1020. In various embodiments, instructions associated with logic for computing device 1000 can overlap in any manner and are not limited to the specific allocation of instructions and/or operations described herein.

In at least one embodiment, processor(s) 1002 is/are at least one hardware processor configured to execute various tasks, operations and/or functions for computing device 1000 as described herein according to software and/or instructions configured for computing device 1000. Processor(s) 1002 (e.g., a hardware processor) can execute any type of instructions associated with data to achieve the operations detailed herein. In one example, processor(s) 1002 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 1004 and/or storage 1006 is/are configured to store data, information, software, and/or instructions associated with computing device 1000, and/or logic configured for memory element(s) 1004 and/or storage 1006. For example, any logic described herein (e.g., control logic 1020) can, in various embodiments, be stored for computing device 1000 using any combination of memory element(s) 1004 and/or storage 1006. Note that in some embodiments, storage 1006 can be consolidated with one or more memory elements 1004 (or vice versa), or can overlap/exist in any other suitable manner.

In at least one embodiment, bus 1008 can be configured as an interface that enables one or more elements of computing device 1000 to communicate in order to exchange information and/or data. Bus 1008 can be implemented with any architecture designed for passing control, data and/or information between processors, memory elements/storage, peripheral devices, and/or any other hardware and/or software components that may be configured for computing device 1000. In at least one embodiment, bus 1008 may be implemented as a fast kernel-hosted interconnect, potentially using shared memory between processes (e.g., logic), which can enable efficient communication paths between the processes.

In various embodiments, network processor unit(s) 1010 may enable communication between computing device 1000 and other systems, entities, etc., via network I/O interface(s) 1012 to facilitate operations discussed for various embodiments described herein. In various embodiments, network processor unit(s) 1010 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 1000 and other systems, entities, etc. to facilitate operations for various embodiments described herein. In various embodiments, network I/O interface(s) 1012 can be configured as one or more Ethernet port(s), Fibre Channel ports, and/or any other I/O port(s) now known or hereafter developed. Thus, the network processor unit(s) 1010 and/or network I/O interface(s) 1012 may include suitable interfaces for receiving, transmitting, and/or otherwise communicating data and/or information in a network environment.

I/O interface(s) 1014 allow for input and output of data and/or information with other entities that may be connected to computing device 1000. For example, I/O interface(s) 1014 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor 1016, a display screen, or the like.

In various embodiments, control logic 1020 can include instructions that, when executed, cause processor(s) 1002 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided. The apparatus includes a memory, a network interface configured to enable network communications, and a processor. The processor is configured to perform operations including obtaining enterprise data about a plurality of assets and configuration of an enterprise network, and partner data about one or more network related partner services for the enterprise network. The operations further include determining one or more hierarchical relationships among the plurality of assets, the enterprise network, and the one or more network related partner services, by performing machine learning on the enterprise data and the partner data. Additionally, the operations include generating one or more risk values based on the one or more hierarchical relationships and providing the one or more risk values indicative of performance of the one or more network related partner services.

In yet another example embodiment, one or more non-transitory computer readable storage media encoded with instructions are provided. When the media is executed by a processor, the instructions cause the processor to execute a method that includes obtaining enterprise data about a plurality of assets and configuration of an enterprise network, and partner data about one or more network related partner services for the enterprise network. The method further includes determining one or more hierarchical relationships among the plurality of assets, the enterprise network, and the one or more network related partner services, by performing machine learning on the enterprise data and the partner data. Additionally, the method involves generating one or more risk values based on the one or more hierarchical relationships and providing the one or more risk values indicative of performance of the one or more network related partner services.

In yet another example embodiment, a system is provided that includes the devices and operations explained above with reference to FIGS. 1-10.

The programs described herein (e.g., control logic 1020) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 1006 and/or memory elements(s) 1004 can store data, software, code, instructions (e.g., processor instructions), logic, parameters, combinations thereof, and/or the like used for operations described herein. This includes the storage 1006 and/or memory elements(s) 1004 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data, or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining enterprise data about a plurality of assets and configuration of an enterprise network, and partner data about one or more network related partner services for the enterprise network;
determining one or more hierarchical relationships among the plurality of assets, the enterprise network, and the one or more network related partner services, by performing machine learning on the enterprise data and the partner data;
generating one or more risk values based on the one or more hierarchical relationships; and
providing the one or more risk values indicative of performance of the one or more network related partner services.

2. The method of claim 1, further comprising:
performing at least one configuration action to the enterprise network based on one or more configuration actions performed by a plurality of similarly situated network related partner services to modify the one or more risk values.

3. The method of claim 1, wherein generating the one or more risk values includes:
generating a respective risk value and an explanation for the respective risk value for each of a plurality of performance categories including one or more of a security risk category, a network device state risk category, a case support category, and a licensing status risk category.

4. The method of claim 1, further comprising:
generating at least one actionable insight for a respective risk value based on a fuzzy rule in which one or more of a similarly situated enterprise or similarly situated network related partner services are considered, wherein the at least one actionable insight includes one or more configuration actions for the enterprise network.

5. The method of claim 1, further comprising:
generating an enterprise data embedding based on the enterprise data, wherein the enterprise data embedding is based on an enterprise profile that includes one or more attributes of an enterprise and is further based on a network topology embedding generated using a graph neural network of the plurality of assets and the configuration of the enterprise network,
wherein the one or more hierarchical relationships are determined based on the enterprise data embedding.

6. The method of claim 5, further comprising:
generating a partner data embedding based on a network related partner services enterprise profile and information about the one or more network related partner services provided to a plurality of enterprises,
wherein the one or more hierarchical relationships are determined based on the partner data embedding.

7. The method of claim 1, wherein determining the one or more hierarchical relationships by performing the machine learning includes:
performing a graph neural network-based deep machine learning of the enterprise data and the partner data to learn the one or more hierarchical relationships between the plurality of assets, the enterprise network, and the one or more network related partner services.

8. The method of claim 1, further comprising:
determining at least one similarly situated enterprise network that shares one or more attributes with the enterprise network and similarly situated network related partner services that share the one or more attributes with the one or more network related partner services, by performing fuzzy based clustering,
wherein determining the one or more risk values is further based on the at least one similarly situated enterprise network and the similarly situated network related partner services.

9. The method of claim 1, further comprising:
determining auxiliary information about at least one other enterprise network that shares one or more attributes with the enterprise network and other network related partner services that share the one or more attributes with the one or more network related partner services,
wherein determining the one or more risk values is further based on the auxiliary information.

10. The method of claim 9, further comprising:
determining an amount of the auxiliary information based on the enterprise data and the partner data; and
fusing the enterprise data and the partner data with the amount of the auxiliary information to determine the one or more risk values.

11. The method of claim 10, further comprising:
generating a partner services risk score and one or more explanations for the partner services risk score by performing adaptive neuro-fuzzy inference machine learning of the enterprise data, the partner data, and the auxiliary information, wherein the partner services risk score is indicative of the performance of the one or more network related partner services with respect to the other network related partner services.

12. An apparatus comprising:
a memory;
a network interface configured to enable network communications; and
a processor, wherein the processor is configured to perform a method comprising:
obtaining enterprise data about a plurality of assets and configuration of an enterprise network, and partner data about one or more network related partner services for the enterprise network;
determining one or more hierarchical relationships among the plurality of assets, the enterprise network, and the one or more network related partner services, by performing machine learning on the enterprise data and the partner data;
generating one or more risk values based on the one or more hierarchical relationships; and
providing the one or more risk values indicative of performance of the one or more network related partner services.

13. The apparatus of claim 12, wherein the processor is further configured to perform an operation comprising:
performing at least one configuration action to the enterprise network based on one or more configuration actions performed by a plurality of similarly situated network related partner services to modify the one or more risk values.

14. The apparatus of claim 12, wherein the processor is configured to generate the one or more risk values by:
generating a respective risk value and an explanation for the respective risk value for each of a plurality of performance categories including one or more of a security risk category, a network device state risk category, a case support category, and a licensing status risk category.

15. The apparatus of claim 12, wherein the processor is further configured to perform:
generating at least one actionable insight for a respective risk value based on a fuzzy rule in which one or more of a similarly situated enterprise or similarly situated network related partner services are considered, wherein the at least one actionable insight includes one or more configuration actions for the enterprise network.

16. The apparatus of claim 12, wherein the processor is further configured to perform:
generating an enterprise data embedding based on the enterprise data, wherein the enterprise data embedding is based on an enterprise profile that includes one or more attributes of an enterprise and is further based on a network topology embedding generated using a graph neural network of the plurality of assets and the configuration of the enterprise network,
wherein the one or more hierarchical relationships are determined based on the enterprise data embedding.

17. The apparatus of claim 16, wherein the processor is further configured to perform:
generating a partner data embedding based on a network related partner services enterprise profile and information about the one or more network related partner services provided to a plurality of enterprises,
wherein the one or more hierarchical relationships are determined based on the partner data embedding.

18. One or more non-transitory computer readable storage media encoded with software comprising computer executable instructions that, when executed by a processor, cause the processor to perform a method including:
obtaining enterprise data about a plurality of assets and configuration of an enterprise network, and partner data about one or more network related partner services for the enterprise network;
determining one or more hierarchical relationships among the plurality of assets, the enterprise network, and the one or more network related partner services, by performing machine learning on the enterprise data and the partner data;
generating one or more risk values based on the one or more hierarchical relationships; and
providing the one or more risk values indicative of performance of the one or more network related partner services.

19. The one or more non-transitory computer readable storage media according to claim 18, wherein the computer executable instructions cause the processor to further perform:
performing at least one configuration action to the enterprise network based on one or more configuration actions performed by a plurality of similarly situated network related partner services to modify the one or more risk values.

20. The one or more non-transitory computer readable storage media according to claim 18, wherein the computer executable instructions cause the processor to further perform:
generating a respective risk value and an explanation for the respective risk value for each of a plurality of performance categories including one or more of a security risk category, a network device state risk category, a case support category, and a licensing status risk category.
